(19) United States
(12) Patent Application Publication
(10) Pub. No.: US 2009/0324983 A1
(43) Pub. Date: Dec. 31, 2009

(54) COMPOSITION AND PROCESS FOR COATING METAL SURFACES

(75) Inventors: Karsten Hackbarth, Duesseldorf (DE); Wolfgang Lorenz, Erkrath (DE); Eva Wilke, Haan (DE); Marcel Roth, Duesseldorf (DE); Reiner Wark, Wuppertal (DE); Stephan Müller, Monheim (DE); Guadalupe Sanchis Otero, Duesseldorf (DE); Manuela Göske-Krajnc, Hilden (DE); Andreas Kunz, Remscheid (DE)

Correspondence Address: HENKEL CORPORATION, One Henkel Way, ROCKY HILL, CT, 06067, US

(73) Assignee: Henkel AG & Co. KGaA, Dusseldorf (DE)

(21) Appl. No.: 12/492,851

(22) Filed: Jun. 26, 2009

Related U.S. Application Data
(63) Continuation of application No. PCT/EP2007/062572, filed on Nov. 20, 2007.

(30) Foreign Application Priority Data
Dec. 28, 2006 (DE) 102006062500.5

(51) Int. Cl. B32B 15/08; C08K 3/08; B05D 3/02; B05D 3/06

(52) U.S. Cl. 428/551; 524/441; 427/518; 427/388.2

(57) ABSTRACT

A composition for coating metal surfaces based on crosslinking polyester resins as an organic constituent, which, based on its total mass, contains from 4 to 20% by weight of aluminum flakes and not more than 0.1% by weight of compounds containing isocyanate groups. The composition preferably comprises, as an organic binder, at least one hydroxylated polyester resin, preferably having a mean molar mass in the range from 2000 to 15,000, a crosslinking component for the hydroxylated polyester resin and an acidic crosslinking catalyst. A process for applying the composition to metal strip in a belt process is likewise disclosed. The layer application is adjusted within the range from 3 to 30 μm according to the end use, for which double coating may be advantageous. For example, the composition may serve as a “galvanization replacement”.

This application is a continuation under 35 U.S.C. Sections 365(c) and 120 of International Application No. PCT/EP2007/062572, filed Nov. 20, 2007 and published on Jul. 10, 2008 as WO 20081080700, which claims priority from German Patent Application No. 102006062500.5 filed Dec. 28, 2006, which are incorporated herein by reference in their entirety.

The present invention relates to anticorrosion compositions for coating metal surfaces and to a process for coating metal surfaces with aluminum-containing organic coatings.

In the metal-processing industry, the metallic constituents of the products must be protected from corrosion. For example in vehicle and domestic appliance construction there is a desire, for reasons of process simplification, to reduce expenditure on chemical anticorrosion treatment. This can be achieved by using raw material in the form of metal sheet or strip already bearing an anticorrosion layer.

It is in principle known to coat sheet steel with organic coatings which are weldable and can be applied directly in the rolling mill by the “coil coating process”.

DE-C-3412234 accordingly describes a conductive and weldable anticorrosion primer for electrolytically thin-galvanized, phosphated or chromated and formable sheet steel. This anticorrosion primer consists of a mixture of more than 60% zinc, aluminum, graphite and/or molybdenum disulfide and a further anticorrosion pigment and 33 to 35% of an organic binder and approx. 2% of a dispersion auxiliary or catalyst. Polyester resins and/or epoxy resins and the derivatives thereof are suggested as the organic binder.

WO 99/24515 discloses a conductive and weldable anticorrosion composition for coating metal surfaces, wherein it contains
a) 10 to 40 wt. % of an organic binder containing
   aa) at least one epoxy resin
   ab) at least one curing agent selected from guanidine, substituted guanidines, substituted ureas, cyclic tertiary amines and mixtures thereof
   ac) at least one blocked polyurethane resin
b) 0 to 15 wt. % of an anticorrosion pigment based on silicate
c) 40 to 70 wt. % of pulverulent zinc, aluminum, graphite and/or molybdenum sulfide, carbon black, iron phosphide
d) 0 to 30 wt. % of a solvent.

WO 01/85860 describes a conductive and weldable anticorrosion composition for coating metal surfaces wherein, relative to the total composition, it contains
a) 5 to 40 wt. % of an organic binder containing
   aa) at least one epoxy resin
   ab) at least one curing agent selected from cyanoguanidine, benzoguanamine and plasticized urea resin
   ac) at least one amine adduct selected from polyoxyalkylenetriamine and epoxy resin/amine adducts
b) 0 to 15 wt. % of an anticorrosion pigment
c) 40 to 70 wt. % of a conductive pigment, selected from pulverulent zinc, aluminum, graphite, molybdenum sulfide, carbon black and iron phosphide
d) 0 to 45 wt. % of a solvent
   and if desired up to 50 wt. % of further active or auxiliary substances, the proportions of the components adding up to 100 wt. %. A number of metal coating compositions which contain particles of metallic aluminum are thus known. The aluminum is here primarily used as a conductive pigment so that the resultant coatings can be electrically welded and optionally electro-dipcoated. These coatings serve as a base for subsequent coating and are not intended either to constitute the sole organic coating or to be overcoated with at most a clear coat.

In order to improve corrosion resistance, steel is frequently galvanized or alloy-galvanized by hot dip or electrolytic processes. These zinc or zinc alloy coatings impart a characteristic silvery metallic appearance to the steel. Surfaces galvanized by hot dipping have a characteristic, frosted appearance due to crystallization of the zinc melt as it solidifies. Depending on the intended application, this may be desired for decorative reasons, but may also be considered troublesome. In contrast, electrolytically deposited zinc or zinc alloy layers have a uniform and homogeneous appearance to the human eye.

This zinc coated (“galvanized”) steel can be overcoated, with adhesion of the coating material on the zinc layer possibly being problematic and entailing specific pretreatment. Frequently, however, zinc coated steel is used uncoated or optionally coated with a clear coat, since the silvery appearance of the zinc layer is considered either decorative or at least not troublesome. Thanks to the cathodic protective action of the zinc layer, which may moreover be passivated by environmental influences, the underlying steel does not rust provided that the zinc layer remains unbroken. Depending on the thickness of the zinc layer and environmental influences, it may take decades for galvanized steel to exhibit red rust.

Galvanizing steel is thus a conventional and widely used anticorrosion protection measure. Galvanization is, however, costly in energy terms and increases the thickness of the material and thus overall consumption of materials. There is accordingly a need for a process which provides ungalvanized steel with a similar appearance and similar anticorrosion protection as galvanization. The present invention provides such a process and a composition for use therein.

The first aspect of the present invention relates to a composition for coating metal surfaces based on crosslinking polyester resins as the organic binder, wherein, relative to its total mass, the composition contains 4 to 20 wt. % of aluminum flakes and no more than 0.1 wt. % of compounds containing isocyanate groups.

The crosslinking polyester resins are particularly suitable for durably enclosing the aluminum flakes and fixing them onto the metal surface so giving rise to a coating with good anticorrosion properties. In order to obtain a maximally isocyanate or polyurethane-free coating, the composition according to the invention contains no more than 0.1 wt. %, preferably no more than 0.01 wt. % and particularly preferably absolutely no detectable compounds containing isocyanate groups. Due to the absence of isocyanate or polyurethanes, the coating is particularly insensitive to environmental influences and in particular to sunlight.

A content of 4 to 20 wt. % of aluminum flakes means that, at a desired thickness of between approx. 3 and approx. 30 μm, the cured coating provides complete visual coverage of the underlying metal surface. The metal surface then looks as if it had been electrolytically galvanized. Thanks to the coating's anticorrosion action, the formation of red rust on steel coated in this manner is suppressed for the long term. The composition thus provides steel coated therewith visual and anticorrosion properties similar to those of galvanized steel. The energy input for application of the coating is, however, lower than that for galvanization. Moreover, the layer obtained with the composition according to the invention is lighter than a galvanization layer, so generating material savings in comparison with galvanization.

Suitable aluminum flakes are commercially available. They may, for example, have an average area diameter in the range from 20 to 60 μm, preferably from 30 to 50 μm, and a thickness in the range from 0.3 to 1 μm, preferably in the range from 0.4 to 0.6 μm. Relative to its total mass, the composition preferably contains 5 to 12 wt. % of aluminum flakes.

The anticorrosion action of the agent according to the invention may be improved if, relative to its total mass, approx. 2 to approx. 10 wt. %, in particular approx. 3 to approx. 7 wt. % of corrosion inhibitors and/or anticorrosion pigments are added thereto. Anticorrosion pigment may for example be selected from calcium or zinc phosphates, magnesium oxide, in particular in nanoscale form, fine-grained or very fine-grained barium sulfate and anticorrosion pigments based on calcium silicate. The latter are preferred due to their particularly good efficacy.

The composition according to the invention conventionally contains, relative to its total mass, 20 to 50 wt. % and in particular 30 to 40 wt. % of organic binder and 30 to 70 wt. %, in particular 50 to 60 wt. % of solvent, the sum of the proportions of solvent and organic binder being no greater than 96 wt. %, preferably no greater than 90 wt. % and in particular no greater than 70 wt. % due to the presence of further constituents such as at least the aluminum flakes.

The components of the organic binder are generally commercially available as a solution or dispersion in an organic solvent. Due to the use of such raw materials, the coating composition according to the invention also contains solvent. The presence of solvents has a favorable impact on the composition's viscosity, which should in particular be adjusted such that the composition can be applied onto a moving metal strip using normal strip coating methods. The viscosity at the particular temperature at which the composition is applied onto the metal strip may be adjusted to the desired range by varying the quantity of solvent. It may therefore be advantageous for the composition according to the invention to contain additional solvent as well as the solvent content of the raw materials. Depending on the raw material used, the solvents present in the composition may be, for example, “solvent naphtha”, diethylene glycol monobutyl ether acetate, propylene glycol methyl ether, cyclohexanone, diacetone alcohol, diethylene glycol, propylene glycol n-butyl ether, methoxypropyl acetate, methoxypropanol, butanol, in particular isobutanol, xylene or further solvents convention in the field of coating materials and paints.

The coating composition according to the invention preferably contains as organic binder at least one hydroxylated polyester resin and a crosslinking component therefor. The hydroxylated polyester resin preferably has an average molar mass in the range from 2000 to 15000, in particular in the range from approx 3000 to approx 10000. Gel permeation chromatography may be selected as the method for determining molar mass. In general, however, molar masses are stated in the manufacturer's technical product data sheets, to which reference may be made for the purposes of the present invention.

Preferably used hydroxylated polyester resins are those which, in a solvent-free state, exhibit an acid value of less than 5, in particular of no more than 3 mg of KOH/g and an OH value in the range from 10 to 50, in particular in the range from 15 to 40 mg of KOH/g.

The crosslinking component selected for the hydroxylated polyester resin is preferably a melamine/formaldehyde crosslinking reagent. A methoxymethyl melamine may, for example, be used, which generally assumes the form of a secondary amine and is alkoxylated on the nitrogen. Such crosslinking agents are commercially available and frequently contain solvent.

The crosslinking reaction on curing of the organic binder may be improved and accelerated if the composition additionally contains at least one acidic crosslinking catalyst, preferably a weakly acidic crosslinking catalyst. The latter is preferably present in blocked form, such that the crosslinking reaction only begins at a temperature which is higher than the storage and application temperature of the composition. A nonionic blocked acidic crosslinking catalyst which is activated at a temperature of above 110° C. is, for example, suitable. Such catalysts for melamine/formaldehyde resin based stoving enamels are commercially obtainable and generally assume the form of a solution in an organic solvent (for example xylene).

A preferably used composition of this type is one which, relative to the total mass of the composition, contains 15 to 40 wt. %, preferably 20 to 35 wt. % of hydroxylated polyester resin, 2 to 10 wt. %, preferably 3 to 8 wt. % of crosslinking component for the hydroxylated polyester resin, 0.05 to 1 wt. %, preferably 0.1 to 0.5 wt. % of acidic crosslinking catalyst.

Apart from these components, the composition according to the invention may contain further additives which are usual in the field of organic coating compositions. They may comprise, for example, fillers, antisettling agents, defoamers or leveling auxiliaries. The composition according to the invention may for example contain inorganic fillers, for example based on mica, quartz and/or chlorite. The average particle size should be compatible with the desired coating thicknesses and should preferably be no greater than 5 μm. The filler should preferably contain no more than 1 wt. % of particles which are larger than 15 μm. Relative to its total mass, the composition preferably contains approx. 2 to approx 20 wt. %, in particular approx. 4 to approx. 10 wt. % of fillers.

A second aspect of the present invention resides in a process for coating metal strip, in particular ungalvanized steel strip by the strip process, wherein

i) the strip is, if necessary, cleaned,
ii) the strip is brought into contact with an acidic treatment solution which produces on the steel surface a conversion layer which contains no more than 1 mg of chromium per m², after which, with or without intermediate rinsing with water,
iii) it is coated with a composition as described above to a wet film thickness such that, after curing, a layer application in the range from 3 to 30 μm is obtained, and
iv) the wet layer applied in step iii) is cured by IR radiation or by heating the strip to a substrate temperature in the range from 120 to 280° C., preferably in the range from 230 to 250° C.

If metal strips are coated which have immediately previously been provided with a metal coating, for example of electrolytic or hot dip zinc or zinc alloy, the metal surfaces need not be cleaned before the conversion treatment (ii) is carried out. If the metal strips have already been stored and in particular provided with anticorrosion oils, a cleaning step is necessary before step (ii) is carried out.

The conversion solution to be used in step (ii) may comprises a layer-forming or non-layer-forming phosphating solution known from the prior art. Alternatively, an acidic treatment solution may be used which contains complex fluorides of silicon and in particular of titanium and/or zirconium as the layer-forming component. The conversion solution may furthermore contain organic polymers such as for example polyacrylates or amino-substituted polyvinylphenol derivatives Adding nanoscale silica or nanoscale alumina to the conversion solution in step (ii) may give rise to further improved anticorrosion and adhesion properties. “Nanoscale” particles are here taken to mean those which on average have a particle diameter of less than 1000 nm, in particular of less than 500 nm.

At least steps (ii) and (iii) are here carried out as strip treatment processes, the liquid treatment agent being applied in step (iii) in a quantity such that, after curing, the desired film thickness in the range from 3 to 30 μm is obtained. The coating composition may here be applied by various processes which are familiar in the prior art. For example, application rollers may be used, with which the desired wet film thickness may be directly established. Alternatively, the metal strip may be immersed in the coating composition or be sprayed with the coating composition, after which the desired wet film thickness is established with the assistance of squeegee rollers.

After application of the liquid treatment agent in step (iii), the coated metal sheet is heated to the necessary drying or crosslinking temperature for the organic coating. The coated substrate may be heated to the necessary substrate temperature (“peak metal temperature”=PMT) in the range from 120 to 280° C., preferably in the range from 230 to 250° C., in a heated tunnel oven. The treatment agent may, however, also be adjusted to the appropriate drying or crosslinking temperature by infrared radiation.

Depending on the subsequent intended application of the metal substrate coated according to the invention, different film thickness ranges are preferred. If a film thickness of more than approx. 10 μm and in particular of more than approx. 15 μm is desired, it may be advisable to carry out coating in two stages, the composition applied in each stage being cured in each case. This procedure is accordingly such that the two steps iii) and iv) are carried out twice and in the first pair of steps iii)+iv) a layer application in the range from 3 to 15 μm is applied and in the second pair of steps iii)+iv) a further layer application in the range from 10 to 27 μm is applied thereon.

For example, in the first pair of steps a film thickness of the order of 5 μm is applied and in the second pair of steps a film thickness of the order of 20 μm is applied. Further conceivable combinations are: approx. 10 μm in the first coating step and approx. 15 μm in the second coating step or approx. 12 μm in the first coating step and likewise approx. 12 μm in the second coating step.

The present invention furthermore comprises a strip or a sheet or component produced therefrom which is obtainable by the process according to the invention. Depending on the desired intended application, the coating thickness may differ and the coating may or many not be overcoated.

In one embodiment, the layer application produced in steps iii) and iv) is in the range from 3 to 10 μm, onto which at least one further coating layer other than a clear coat is applied. In this embodiment, the coating according to the invention therefore acts as a primer for a subsequent coating. While the above-explained visual similarity to a galvanization layer is indeed lost in this case, use is made of the anticorrosion action of the coating applied according to the invention. Such opaquely overcoated metal sheet may for example be used or produced in vehicle construction or in the production of domestic appliances or metal furniture. It may then in each case form the outside of the stated products. The overcoating may for example comprise a CED (cathodic ectro-dipcoat) coating material or a powder coating.

In a further embodiment, after curing in step iv), the coating applied according to the invention is present in a film thickness in the range from approx. 3 to approx. 15 μm and in particular in the range from approx. 8 to approx. 14 μm. Without being further overcoated, it then provides sufficient anticorrosion protection to serve as a “reverse-side coating”. It thus provides cover for internal surfaces of for example vehicles, furniture or domestic appliances not exposed to severe corrosion, which is sufficient to ensure that no further overcoating is necessary.

If the coating according to the invention is to be located on the outside of the articles produced from the coated substrate and is furthermore not to be overcoated or at most overcoated with a clear coat, an overall layer application in the range from approx. 20 to 30 μm is preferably produced. This is preferably produced by the above-explained two-stage process, in which steps iii) and iv) are carried out twice in succession.

In this embodiment, a metal strip or a sheet or component produced therefrom is obtained in which the coating applied according to the invention is either not overcoated on the surface of the component or is at most coated with a clear coat. In this embodiment, the galvanization-like appearance of the coating according to the invention is visible, which may be desired for aesthetic reasons. In this embodiment, the coating according to the invention serves as it were as a “galvanization substitute”. Both the visual impression and the anticorrosion action of a galvanized steel surface is produced in less costly manner without having to make use of galvanization, which is more costly in terms of energy and material consumption.

In this embodiment, in which the coating according to the invention remains visible, the strip or a sheet or component produced therefrom is preferably used to produce domestic appliances or architectural parts, in particular for building walls or roofs or for external cladding of building walls or roofs. The metal sheets coated in this embodiment may thus be used for any intended applications for which galvanized steel which has not been overcoated or at most provided with a clear coat is used. Apart from the examples already mentioned, such applications may also be for example gutters on buildings or air conditioning or inlet or exhaust air ducting. Material coated in this manner may furthermore be used for railings or posts, for example as supports for traffic lights or traffic signs. Fences, gates, crash barriers, containers such as for example garbage containers are further possible uses for the material coated according to the invention as a “galvanization substitute”.

On the basis of the above explanations regarding action as a “galvanization substitute”, it is clear that the preferred substrate is ungalvanized steel, in particular cold-rolled steel. Other metals usual in vehicle construction, in the domestic appliance and furniture industry, such as for example zinc or aluminum or in each case the alloys thereof, may however likewise be coated with the composition or by the process according to the invention. The same applies to galvanized or alloy-galvanized steel. In the latter-stated cases, the visual effect of the “galvanization substitute” is of less significance than the anticorrosion action. A composition according to the invention may for example be of the following composition (quantities stated in wt. % relative to total mass):

TABLE 1

| Component | | | | | | | |
|---|---|---|---|---|---|---|---|
| no. | Example 1 | Example 2 | Example 3 | Example 4 | Example 5 | Example 6 | Example 7 |
| 1 | 25.22 | 22.75 | 22.75 | | | | |
| 2 | 1.80 | 3.90 | 3.90 | | | | |
| 7 | | | | 13.75 | 13.75 | 13.75 | 26.95 |
| 8 | | | | 15.00 | 15.00 | 15.00 | |
| 9 | 5.85 | 5.85 | 5.85 | 5.40 | 5.40 | 5.40 | 5.85 |
| 10 | 4.00 | 6.00 | 6.00 | 5.00 | 5.00 | | 6.00 |
| 11 | | | | | | 8.00 | |
| 16 | 3.00 | 10.00 | 10.00 | 10.00 | | | |
| 17 | | | | | 7.00 | 10.00 | |
| 19 | | | | | | | 10.00 |
| 21 | | | | | 0.50 | | |
| 22 | | 1.00 | 0.25 | 0.25 | 0.25 | 0.25 | 0.25 |
| 23 | | | | | 10.00 | | |
| 24 | | | | 10.00 | | 10.00 | |
| 27 | 10.00 | 5.00 | 5.00 | | | | |
| 28 | | | | | | | 5.00 |
| 29 | 15.00 | 17.00 | 18.50 | | 4.50 | | |
| 30 | 10.00 | 5.00 | 5.00 | 16.50 | 8.35 | 6.35 | 17.00 |
| 31 | | | | | 2.00 | | |
| 32 | | | | 2.00 | 2.80 | 2.00 | |
| 33 | 9.70 | 6.50 | 6.50 | | 5.00 | | 6.00 |
| Solvent from | 15.43 | 16.70 | 15.95 | 22.10 | 20.45 | 29.25 | 22.95 |
| raw | | | | | | | |
| materials | | | | | | | |
| Total | 100.00 | 99.70 | 99.70 | 100.00 | 100.00 | 100.00 | 100.00 |

TABLE 2

| | 1 | 2 | 3 | 4 | 5 | 6 | 7 |
|---|---|---|---|---|---|---|---|
| Pigment/ | 0.52 | 0.63 | 0.64 | 0.73 | 0.63 | 0.81 | 0.64 |
| binder ratio | | | | | | | |
| Solids (%) | 49.87 | 54.50 | 53.75 | 59.40 | 56.90 | 62.40 | 54.05 |
| Pigment | 17.00 | 21.00 | 21.00 | 25.00 | 22.00 | 28.00 | 21.00 |
| fraction (%) | | | | | | | |
| Solid binder | 32.87 | 33.50 | 32.75 | 34.40 | 34.90 | 34.40 | 33.05 |
| fraction (%) | | | | | | | |

TABLE 3

| Component | | | Example | Example | Example | Example | Example |
|---|---|---|---|---|---|---|---|
| no. | Example 8 | Example 9 | 10 | 11 | 12 | 13 | 14 |
| 3 | | | | | 26.65 | | |
| 6 | | 4.00 | | | | | |
| 7 | 13.75 | 13.75 | 13.75 | 13.75 | | | 13.75 |
| 8 | 15.00 | 15.00 | 15.00 | 15.00 | | 27.00 | 15.00 |
| 9 | 5.40 | 5.40 | 5.40 | 7.20 | 5.85 | 5.85 | 5.40 |
| 10 | 5.00 | | | 5.00 | 6.00 | 6.00 | |
| 12 | | | 2.50 | | | | |
| 13 | | | | | | | 5.00 |
| 14 | | | 2.50 | | | | |
| 15 | | 5.00 | | | | | |
| 16 | | 10.00 | 10.00 | 10.00 | 10.00 | 10.00 | 10.00 |
| 20 | 20.00 | | | | | | |
| 22 | 0.25 | 0.25 | 0.25 | 0.25 | 0.25 | 0.25 | 0.25 |
| 24 | 10.00 | 10.00 | 10.00 | 10.00 | | | 10.00 |
| 27 | | | | | 5.00 | 5.00 | |
| 30 | 8.50 | 14.50 | 18.50 | 16.50 | 25.00 | 21.00 | 18.50 |
| 33 | | | | | 6.00 | 6.00 | |
| Solvent from | 22.10 | 22.10 | 22.10 | 22.30 | 15.25 | 18.90 | 22.10 |
| raw | | | | | | | |
| materials | | | | | | | |
| Total | 100.00 | 100.00 | 100.00 | 100.00 | 100.00 | 100.00 | 100.00 |

TABLE 4

| | 8 | 9 | 10 | 11 | 12 | 13 | 14 |
|---|---|---|---|---|---|---|---|
| Pigment/ | 1.02 | 0.65 | 0.73 | 0.69 | 0.64 | 0.63 | 0.73 |
| binder ratio | | | | | | | |
| Solids (%) | 69.40 | 63.40 | 59.40 | 61.20 | 53.75 | 54.10 | 59.40 |
| Pigment | 35.00 | 25.00 | 25.00 | 25.00 | 21.00 | 21.00 | 25.00 |
| fraction (%) | | | | | | | |
| Solid binder | 34.40 | 38.40 | 34.40 | 36.20 | 32.75 | 33.10 | 34.40 |
| fraction (%) | | | | | | | |

TABLE 5

| Components | Example | Example | Example | Example | Example | Example | Example | Example |
|---|---|---|---|---|---|---|---|---|
| no. | 15 | 16 | 17 | 18 | 19 | 20 | 21 | 22 |
| 1 | 25.22 | 25.22 | 25.22 | | | | 25.22 | 25.22 |
| 2 | 1.80 | 1.80 | 1.80 | | | | 1.80 | 1.80 |
| 4 | 4.78 | 4.78 | 4.78 | | | | 4.78 | 4.78 |
| 5 | | 2.50 | | | | | | |
| 6 | 5.00 | | 5.00 | | | | 5.00 | 5.00 |
| 7 | | | | 26.95 | 26.95 | 13.75 | | |
| 8 | | | | | | 15.00 | | |
| 9 | | | | 5.85 | 5.85 | 5.40 | | |
| 10 | 4.00 | 4.00 | 4.00 | 6.00 | 6.00 | 5.00 | 4.00 | 4.00 |
| 13 | | | 5.00 | | | | 5.00 | 5.00 |
| 16 | 3.00 | 3.00 | 3.00 | 10.00 | 10.00 | | 3.00 | 3.00 |
| 18 | | | | | | 10.00 | | |
| 22 | 0.25 | 0.25 | 0.25 | 0.25 | 0.25 | 0.25 | 0.25 | 0.25 |
| 24 | | | | | | 10.15 | | |
| 25 | | | | 8.05 | | | | |
| 26 | | | | | 8.05 | | | |
| 27 | 5.00 | 5.00 | 5.00 | | | | 5.00 | 5.00 |
| 29 | 20.00 | 20.80 | 20.00 | 10.00 | 10.00 | 4.50 | 20.00 | 20.00 |
| 30 | 5.00 | 5.00 | 5.00 | 5.75 | 5.75 | 5.15 | 5.00 | 5.00 |
| 31 | | | | | | 2.00 | | |
| 32 | | | | | | 2.80 | | |
| 33 | 9.80 | 9.00 | 4.80 | 6.50 | 6.50 | 4.70 | 4.80 | 4.80 |
| Solvent from | 16.15 | 18.65 | 16.15 | 20.65 | 20.65 | 21.30 | 16.15 | 16.15 |
| raw | | | | | | | | |
| materials | | | | | | | | |
| Total | 100.00 | 100.00 | 100.00 | 100.00 | 100.00 | 100.00 | 100.00 | 100.00 |

TABLE 6

| | 15 | 16 | 17 | 18 | 19 | 20 | 21 | 22 |
|---|---|---|---|---|---|---|---|---|
| Pigment/ | 0.32 | 0.35 | 0.46 | 0.73 | 0.73 | 0.73 | 0.46 | 0.46 |
| binder ratio | | | | | | | | |
| Solids (%) | 49.05 | 46.55 | 54.05 | 57.10 | 57.10 | 59.55 | 54.05 | 54.05 |
| Pigment | 12.00 | 12.00 | 17.00 | 24.05 | 24.05 | 25.15 | 17.00 | 17.00 |
| fraction (%) | | | | | | | | |
| Solid binder | 37.05 | 34.55 | 37.05 | 33.05 | 33.05 | 34.40 | 37.05 | 37.05 |
| fraction (%) | | | | | | | | |

The following definitions apply:

### Component 1

1 branched saturated polyester, acid value <3, OH value 45, molar mass: 3000, 65% in SN 150/BG
2 linear saturated polyester, acid value <3, OH value 15, molar mass: 7,000, 60% in SN150/DBE
3 linear saturated polyester, acid value <3, OH value 35, molar mass: 3,000, 60% in SN150/BG
4 methyl butyl melamine resin, 82% in butanol
5 linear saturated polyester, acid value <3, OH value 5-10, molar mass: 15,000, pellets
6 polycarbonate/polyester containing OH groups, equivalent weight 1000, 100%
7 linear saturated polyester, acid value <3, OH value 20, molar mass: 5,000, 55% in SN150, methoxypropyl acetate, methoxypropanol
8 linear saturated polyester, acid value <3, OH value 25-35, molar mass: 5,000, 60% in SN150, methoxypropyl acetate, methoxypropanol
9 methylated melamine/formaldehyde crosslinking reagent
10 anticorrosion pigment based on calcium silicate
11 anticorrosion pigment based on oxyaminophosphate, magnesium salt
12 anticorrosion pigment based on a modified Sr/Al polyphosphate
13 anticorrosion pigment based on oxyaminophosphate, magnesium salt
14 anticorrosion pigment based on Zn/Al polyphosphate/silicate
15 anticorrosion pigment based on Zn/Al polyphosphate
16 inorganic filler based on talcum
17 inorganic filler based on mica, quartz, chlorite
18 inorganic filler based on barium sulfate
19 inorganic filler based on mica
20 inorganic filler based on kaolin
21 silicone-free leveling agent
22 nonionic blocked acidic crosslinking catalyst
23 aluminum powder, type 1
24 aluminum powder, type 1
25 aluminum powder, type 2
26 aluminum powder, type 3
27 aluminum powder, type 4
28 aluminum powder, type 1
29 solvent naphtha
30 solvent naphtha
   31 solvent naphtha
   32 propylene glycol methyl ester
33 diethylene glycol monobutyl ether acetate

1. A composition for coating metal surfaces comprising:
a) an organic binder comprising at least one hydroxylated polyester resin, said resin in a solvent-free state having an acid value of less than 5 mg of KOH/g and an OH value in a range from 10 to 50 mg of KOH/g;
b) 4 to 20 wt. %, relative to total mass of the composition, of aluminum flakes having an average area diameter in ranging from 20 to 60 μm and a thickness in ranging from 0.3 to 1 μm;
c) a crosslinking component for the hydroxylated polyester resin; and
d) at least one acidic crosslinking catalyst;
said composition comprising no more than 0.1 wt. % of compounds containing isocyanate groups.

2. The composition as claimed in claim 1, wherein the at least one hydroxylated polyester resin has an average molar mass ranging from 2000 to 15000.

3. The composition as claimed in claim 1, wherein the crosslinking component c) comprises at least one melamine/formaldehyde crosslinking reagent.

4. The composition as claimed in claim 1, wherein the at least one acidic crosslinking catalyst is in blocked form and is activated at a temperature of above 110° C.

5. The composition as claimed in claim 1, further comprising 2 to 10 wt. %, relative to total mass of the composition, of corrosion inhibitors or anticorrosion pigment.

6. The composition as claimed in claim 1, further comprising:
a solvent in an amount of 30 to 70 wt. %, relative to total mass of the composition;
wherein the organic binder is present in an amount of 20 to 50 wt. %, relative to the total mass of the composition; and the amounts of the solvent and the organic binder comprise no greater than 96 wt. % of the total mass of the composition.

7. The composition as claimed in claim 1, comprising, relative to the total mass of the composition:
said at least one hydroxylated polyester resin in an amount of 15 to 40 wt. %;
said crosslinking component for the hydroxylated polyester resin in an amount of 2 to 10 wt. %; and
said acidic crosslinking catalyst in an amount of 0.05 to 1 wt. %.

8. A process for coating metal strip comprising steps of:
i) optionally, cleaning a metal strip;
ii) contacting a metal surface of the metal strip with an acidic treatment solution thereby producing on the metal surface a conversion layer comprising no more than 1 mg of chromium per m²;
iii) coating the metal strip having said conversion layer with a coating composition comprising, relative to total mass of said coating composition:
20 to 50 wt. % of an organic binder; and
30 to 70 wt. % of a solvent;
wherein the solvent and the organic binder comprise no greater than 96 wt. % of the total mass of said coating composition, to form a wet film having a thickness such that, after curing, a layer application in a range from 3 to 30 μm is obtained,
wherein said coating composition comprises:
a) an organic binder comprising at least one hydroxylated polyester resin, said resin in a solvent-free state having an acid value of less than 5 mg of KOH/g and an OH value in a range from 10 to 50 mg of KOH/g,
b) 4 to 20 wt. %, relative to total mass of the composition, of aluminum flakes having an average area diameter ranging from 20 to 60 μm and a thickness in ranging from 0.3 to 1 μm,
c) a crosslinking component for the hydroxylated polyester resin; and
d) at least one acidic crosslinking catalyst;
said composition comprising no more than 0.1 wt. % of compounds containing isocyanate groups; and
iv) curing said wet layer applied in step iii) by IR radiation or by heating the metal strip to a substrate temperature ranging from 120 to 280° C.

9. The process as claimed in claim 8, wherein the crosslinking component c) of the coating composition in step iii) comprises at least one melamine/formaldehyde crosslinking reagent.

10. The process as claimed in claim 8, wherein the acidic crosslinking catalyst d) of the coating composition in step iii) is in blocked form and is activated at a temperature of above 110° C.

11. The process as claimed in claim 8, wherein the coating composition in step iii) further comprises 2 to 10 wt. %, relative to total mass of the coating composition, of corrosion inhibitors or anticorrosion pigment.

12. The process as claimed in claim 8, wherein the coating composition in step iii) comprises, relative to the total mass of the composition:
said at least one hydroxylated polyester resin in an amount of 15 to 40 wt. %;
said crosslinking component for the hydroxylated polyester resin in an amount of 2 to 10 wt. %; and
said acidic crosslinking catalyst in an amount of 0.05 to 1 wt. %.

13. The process as claimed in claim 8, wherein said layer application of step iii) ranges from 3 to 15 μm and said process further comprises performing steps iii) and iv) a second time, wherein a further layer application ranging from 10 to 27 μm is applied.

14. The process as claimed in claim 8, wherein the metal strip is ungalvanized steel strip.

15. A metal strip or sheet, or a component produced therefrom, made by a process in accordance with claim 8, wherein no further coating layer is applied.

16. The metal strip or sheet, or a component produced therefrom as claimed in claim 15, wherein the layer application produced in steps iii) and iv) ranges from 3 to 10 μm, and further comprising at least one additional coating layer other than a clear coat.
